(19) United States
(12) Patent Application Publication
(10) Pub. No.: US 2026/0147349 A1
(43) Pub. Date: May 28, 2026

(54) ROBOTIC DEVICE FOR DETERMINING A NAVIGABLE PATH IN AN ENVIRONMENT

(71) Applicant: RN CHIDAKASHI TECHNOLOGIES PVT. LTD, MUMBAI (IN)

(72) Inventors: Shubham Agrawal, Hyderabad (IN); Simit Pradhan, Hyderabad (IN)

(21) Appl. No.: 19/403,544

(22) Filed: Nov. 28, 2025

(30) Foreign Application Priority Data
Nov. 28, 2024 (IN) 202421093253

(51) Int. Cl. G05D 1/246; G05D 1/633; G06T 15/08; G06T 15/20; G06V 20/58

(52) U.S. Cl. CPC G05D 1/2465; G05D 1/633; G06T 15/08; G06T 15/20; G06V 20/58; G06T 2215/12

(57) ABSTRACT

An embodiment herein provides a robotic device 100 that enables real-time autonomous navigation in a dynamic environment by determining a navigable space. The robotic device includes at least one image capturing device 102 to capture at least one image or video within a current Field of View (FOV) of the dynamic environment, and a processor 106 that is configured to obtain the point cloud, identify at least one obstacle in the dynamic environment, generate a local map that represents an occupied region and a free region, construct a virtual wall representing an imaginary boundary positioned at a pre-determined distance, project a plurality of rays from an origin of the at least one image capturing device toward the virtual wall at varying angles, determine at least one visible region of the virtual wall, update the local map and enable the robotic device to navigate to a target location.

### BACKGROUND

### Technical Field

The embodiments herein generally relate to autonomous navigation, more particularly, to a robotic device and a method for determining navigable space and obstacles in a dynamic environment.

### Description of the Related Art

In various applications, such as autonomous navigation, robotics, and augmented reality, accurately distinguishing between occupied and free space is crucial. This capability allows systems to make real-time decisions about safe movement paths and obstacle avoidance. However, achieving efficient and accurate free-space identification presents several technical challenges due to limitations in the way depth data is captured and processed. For real-time applications, minimizing processing time is crucial and in environments with moving objects, it's necessary to continuously update the map to clear or adjust for dynamic obstacles.

Ray casting is a computer graphics and computational geometry technique used to determine the path a “ray” takes from a source point through space, intersecting with objects along its path. In 3D applications, ray casting helps identify where a virtual line, or “ray,” intersects objects in a digital environment. It is widely used in applications like rendering, computer vision, gaming, 3D scanning, and robotics for tasks such as object detection, collision detection, and scene rendering.

In ray casting, the process starts by projecting a ray from a specific point, often from the position of a camera or sensor, and in a specific direction. This ray is then extended into the environment until it intersects an object. If an intersection is found, it provides information about the space to the object, the angle of incidence, and the object's surface characteristics. If no object is encountered, the ray is considered to extend into free space. By casting multiple rays across an environment, ray casting can map surfaces, detect obstacles, and measure distances, contributing to an understanding of spatial layout and object locations.

Ray casting has diverse applications in various fields, including: rendering and computer graphics, collision detection in gaming and robotics, 3D scanning and mapping.

Despite its widespread utility, ray casting has limitations, especially when applied to real-time, resource-intensive environments. Ray casting requires a large number of rays to be cast to cover an entire scene, especially in high-resolution or detailed environments. This requires significant computational power and memory, making it demanding in real-time applications. In complex scenes, the number of rays that must be cast to capture details accurately can slow down performance, as each ray requires calculations for intersections with multiple objects in the scene. This can lead to frame rate drops in real-time applications like gaming or robotics, where rapid processing is crucial. In environments with moving objects, ray casting needs to be repeated frequently to reflect changes, which further increases computational demands.

In systems relying on 3D depth sensors, such as stereoscopic cameras or Time-of-Flight (ToF) cameras, depth images provide pixel-based distance information. Each pixel in a depth image represents the distance from the camera to a point in the environment, but lacks directional data. Unlike LiDAR, where rays inherently carry direction information, depth cameras produce depth maps without defining the path or angle of the ray for each pixel. This makes it difficult to infer spatial orientations directly and complicates tasks like identifying free or navigable space.

In autonomous navigation, for example, ray casting may fail to detect obstacles behind large foreground objects, leading to incomplete or inaccurate spatial mapping. Ray casting can struggle with transparent or reflective surfaces, as rays may pass through or bounce off these surfaces in unpredictable ways. In the real world, objects like glass or mirrors can distort the path of rays, resulting in unreliable or incorrect intersections.

Ray casting is limited by the field of view of the sensor or camera casting the rays. If an object falls outside this field, it will not be detected, potentially leading to blind spots in spatial mapping. Ray casting requires well-calibrated sensors for precise spatial mapping. Any misalignment, distortion, or inaccuracies in the sensors can lead to incorrect ray casting results, affecting the accuracy of object detection and spatial mapping. For applications in autonomous vehicles or robotics, precise calibration is essential to ensure safe navigation. Inaccuracies can lead to errors in distance measurement, collision detection, and obstacle avoidance.

While ray casting is a powerful tool for spatial mapping and collision detection, it faces significant challenges in terms of computational demand, data accuracy, and environmental constraints. The limitations associated with processing point cloud data, handling occlusions, dealing with reflective and transparent surfaces, and interpreting depth images without directional information restrict its efficiency in complex and dynamic environments. Overcoming these limitations typically requires enhanced algorithms, optimized hardware, and complementary data processing techniques, especially for real-time applications in robotics, autonomous navigation, and augmented reality. This technique, however, is computationally demanding and can become inefficient when applied to dense point cloud data from 3D depth sensors.

Effective free-space identification is essential in applications where systems must react and adapt to their surroundings in real-time. However, 3D depth sensors/cameras present unique challenges, as their pixel data does not inherently indicate the direction for ray tracing like in 3D LiDAR systems. Consequently, without a clear directional component, determining navigable paths using depth images alone becomes challenging.

Each pixel in a depth image captures the space/distance to an object but lacks directional data, which is critical for tracing a ray or determining the orientation of obstacles and free space. In contrast, 3D LiDAR systems provide direct ray-tracing capability, enabling easier spatial analysis. Depth sensors, however, require additional processing to infer directional data from raw depth values, making it more difficult to quickly and accurately map navigable paths/areas.

Point cloud data is inherently dense and complex, as it consists of numerous data points that must be processed to map out the environment. Extracting navigable paths/areas from this data can be computationally expensive, particularly in real-time applications. High computational demands can lead to slower processing times and reduced system performance, especially in dynamic environments where obstacles may be constantly moving or changing.

Therefore, there arises a need to address the aforementioned technical drawbacks in the identification of navigable or free space in the current field of view of an image capturing device.

### SUMMARY OF THE INVENTION

An embodiment herein provides a robotic device that enables real-time autonomous navigation in a dynamic environment by determining a navigable space. The robotic device includes at least one image capturing device, a memory and a processor. The at least one image capturing device is configured to capture at least one image or video within a current Field of View (FOV) of the dynamic environment. The at least one image or video includes a point cloud representing 3D points within the current FOV. The memory is configured to store one or more instructions. The processor is configured to execute the one or more instructions. The processor is configured to obtain the point cloud from the at least one image capturing device. The processor is configured to identify at least one obstacle in the dynamic environment by clustering the 3D points within the point cloud based on spatial proximity and point-density values. The processor is configured to generate a local map that represents an occupied region including locations of the at least one obstacle as voxels, and a free region including locations of surroundings of the at least one obstacle as voxels. The processor is configured to construct a virtual wall representing an imaginary boundary positioned at a pre-determined distance from the at least one image capturing device within the current FOV. The processor is configured to project a plurality of rays from an origin of the at least one image capturing device toward the virtual wall at varying angles. The processor is configured to determine at least one visible region of the virtual wall by identifying the rays that reach the virtual wall without intersecting any voxels corresponding to the at least one obstacle. The processor is configured to update the local map by assigning navigability to the at least one visible region of the virtual wall by updating the corresponding voxels as the free region. The processor is configured to enable the robotic device to navigate to a target location in the dynamic environment using the updated local map, thereby enabling the robotic device for real-time autonomous navigation in the dynamic environment.

In some embodiments, the processor is configured to generate the local map by converting the point cloud into the voxels, and assign occupancy values to each voxel of the occupied region and the free region.

In some embodiments, the virtual wall is positioned at a distance corresponding to the maximum measurable range of the at least one image capturing device. The virtual wall is divided into voxels including a plurality of grid cells.

In some embodiments, the processor is configured to integrate the local map into a global map that represents a cumulative layout of the environment for longer range navigation.

In some embodiments, the processor is configured to extend the construction of the virtual wall into 3D voxel grids to generate a 3D map of the dynamic environment comprising volumetric occupied region voxels and volumetric free region voxels when the robotic device requires a 3D representation.

In some embodiments, the processor is configured to determine visibility of each grid cell by projecting the plurality of rays from respective centers of the 3D voxel grids on the virtual wall toward the origin of the at least one image capturing device.

In some embodiments, the processor is configured to dynamically clear at least one of: (i) the occupied region associated with previously detected obstacle voxels when corresponding obstacle is not detected in a subsequent point cloud, or (ii) the free region associated with previously detected surrounding voxels when corresponding surroundings is not detected in a subsequent point cloud.

In some embodiments, the processor is configured to: identify the at least one obstacle by grouping the 3D points into at least one cluster based on a threshold of the spatial proximity value, and determine an area of the point cloud with point-density values exceeding a threshold of the point-density value.

In some embodiments, the processor is configured to adjust a position or shape of the virtual wall based on calibration data of the at least one image capturing device.

In an aspect, a method for enabling real-time autonomous navigation in a dynamic environment by determining a navigable space is provided. The method includes obtaining a point cloud representing 3D points within a current Field of View (FOV), using at least one image capturing device. The method includes identifying at least one obstacle in the dynamic environment by clustering the 3D points within the point cloud based on spatial proximity and point-density values. The method includes generating a local map that represents an occupied region comprising locations of the at least one obstacle as voxels, and a free region comprising locations of surroundings of the at least one obstacle as voxels. The method includes constructing a virtual wall representing an imaginary boundary positioned at a pre-determined distance from the at least one image capturing device within the current FOV. The method includes projecting a plurality of rays from an origin of the at least one image capturing device toward the virtual wall at varying angles. The method includes determining at least one visible region of the virtual wall by identifying the rays that reach the virtual wall without intersecting any voxels corresponding to the at least one obstacle. The method includes updating the local map by assigning navigability to the at least one visible region of the virtual wall by updating the corresponding voxels as the free region. The method includes enabling the robotic device to navigate to a target location in the dynamic environment using the updated local map, thereby enabling the robotic device for real-time autonomous navigation in the dynamic environment.

The robotic device improves a reliability of detecting free spaces and avoid obstacles by refining processing methods applied to depth and the point cloud. The robotic device reduces a computational load and speeding up the identification of the free space by analysing the point cloud. Optimized processing time enables faster response rates, making the robotic device more responsive and efficient in dynamic environments. In environments with moving objects, it's necessary to continuously update the local map to clear or adjust for dynamic obstacles. The robotic device promptly identifies and removes the obstacles from the mapped free space, allowing the robotic device to adapt quickly to changes in the dynamic environment, which enhances the ability of the robotic device to maintain an accurate representation of free space, even in unpredictable settings.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a robotic device for enabling real-time autonomous navigation in a dynamic environment according to some embodiments herein;

FIG. 2 illustrates an exploded view of the robotic device according to some embodiments herein;

FIG. 3 illustrates an exemplary illustration of the robotic device of FIG. 1 enabling real-time autonomous navigation in a dynamic environment according to some embodiments herein;

FIG. 4 illustrates a block diagram of the robotic device including one or more modules according to some embodiments herein;

FIGS. 5A and 5B illustrate a method for enabling real-time autonomous navigation in a dynamic environment by determining a navigable space according to some embodiments herein;

FIGS. 6A-6C illustrate experimental data including a visual evidence and comparison between the robotic system of FIG. 1 and closest existing approach for real-time obstacle detection and free-space identification in a dynamic environment according to some embodiments herein;

FIGS. 7A-7C illustrate another experimental data including a visual evidence and comparison between the robotic device of FIG. 1 and the closest existing approach for real-time obstacle detection and free-space identification in a dynamic environment according to some embodiments herein; and

FIG. 8 illustrates an exemplary view of the robotic device for detecting navigable/free space and obstacles in a 3-Dimensional (3D) environment according to some embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

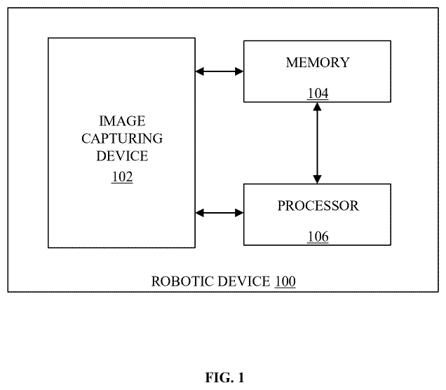

As mentioned, there remains a need for a robotic device and a method that enables real-time autonomous navigation in a dynamic environment by determining a navigable/free space. Referring now to the drawings, and more particularly to FIGS. 1 through 8, where similar reference characters denote corresponding features consistently throughout the figures', preferred embodiments are shown.

FIG. 1 illustrates a robotic device 100 for enabling real-time autonomous navigation in a dynamic environment according to some embodiments herein. The robotic device 100 includes at least one image capturing device 102, a memory 104 and a processor 106. The image capturing device 102 is configured to capture at least one image or video within a current Field of View (FOV) of the dynamic environment. The at least one image or video includes a point cloud representing 3D points within the current FOV. In some embodiments, the 3D points correspond to obstacles in the environment. The memory 104 is configured to store one or more instructions, and the processor 106 is configured to execute the one or more instructions. In some embodiments, the one or more instructions enable the robotic device 100 for real-time autonomous navigation in the dynamic environment. The dynamic environment may be a 2-dimensional environment or a 3-dimensional environment.

The processor 106 is configured to obtain the point cloud from the at least one image capturing device 102. The processor 106 is configured to identify at least one obstacle in the dynamic environment by clustering the 3D points within the point cloud based on spatial proximity and point-density values. In some embodiments, the processor 106 is configured to identify the at least one obstacle by grouping the 3D points into at least one cluster based on a threshold of the spatial proximity value, and determine an area of the point cloud with point-density values exceeding a threshold of the point-density value.

The processor 106 is configured to generate a local map that represents an occupied region including locations of the at least one obstacle as voxels, and a free region including locations of surroundings of the at least one obstacle as voxels. The local map may represent both the at least one obstacle and surroundings of the at least one obstacle. The surroundings of the at least one obstacle may be a navigable space. In some embodiments, the processor 106 is configured to generate the local map by converting the point cloud into the voxels, and assign occupancy values to each voxel of the occupied region and the free region.

The processor 106 is configured to construct a virtual wall representing an imaginary boundary positioned at a pre-determined distance from the at least one image capturing device 102 within the current FOV. The pre-determined distance may be in a range of 1 meter to 10 meters. In some embodiments, the pre-determined distance varies from 0.1 meter to 1 meter. The pre-determined distance may be determined based on the at least one image capturing device 102. In some embodiments, the virtual wall is positioned at a distance corresponding to the maximum measurable range of the at least one image capturing device 102. The virtual wall may be positioned at the distance corresponding to the maximum depth range of the at least one image capturing device 102. In some embodiments, the virtual wall represents the farthest boundary detectable by the at least one image capturing device 102. The virtual wall may be divided into voxels including a plurality of grid cells. The processor is may be configured to adjust a position or shape of the virtual wall based on calibration data of the at least one image capturing device 102. In some embodiments, the processor 106 is configured to construct a plurality of virtual walls for each of the current FOV in the dynamic environment.

The processor 106 is configured to project a plurality of rays from an origin of the at least one image capturing device 102 toward the virtual wall at varying angles. In some embodiments, the processor 106 project the plurality of rays within a horizontal FOV. The processor 106 is configured to determine at least one visible region of the virtual wall by identifying the rays that reach the virtual wall without intersecting any voxels corresponding to the at least one obstacle.

The processor 106 is configured to update the local map by assigning navigability to the at least one visible region of the virtual wall by updating the corresponding voxels as the free region. In some embodiments, the processor 106 is configured to dynamically clear at least one of: (i) the occupied region associated with previously detected obstacle voxels when corresponding obstacle is not detected in a subsequent point cloud, or (ii) the free region associated with previously detected surrounding voxels when corresponding surroundings is not detected in a subsequent point cloud. In some embodiments, the processor 106 dynamically update the local map when the at least one obstacle has moved or is no longer detected in the specified FOV in the environment, enabling real-time adjustments in the local map.

The processor 106 is configured to enable the robotic device to navigate to a target location in the dynamic environment using the updated local map, thereby enabling the robotic device for real-time autonomous navigation in the dynamic environment. In some embodiments, the processor 106 generates a navigation plan based on the updated local map to from an origin point to the target location. The navigation plan may include one or more movement instructions of the robotic device 100. In some embodiments, the one or more movement instructions provides a pre-determined path on the updated local map.

The processor 106 may be configured to integrate the local map into a global map that represents a cumulative layout of the environment for longer range navigation. In some embodiments, the processor 106 is configured to extend the construction of the virtual wall into 3D voxel grids to generate a 3D map of the dynamic environment including volumetric occupied region voxels and volumetric free region voxels when the robotic device requires a 3D representation. The processor 106 discretizes the portion of the virtual wall at the maximum depth cutoff plane into a finite number of grid cells i.e. the 3D voxel grids. The processor 106 may be configured to determine visibility of each grid cell by projecting the plurality of rays from respective centers of the 3D voxel grids on the virtual wall toward the origin of the at least one image capturing device 102.

In some embodiments, the processor 106 is configured to process the point cloud to reduce computational complexity by selectively processing only those data points that lie within a specified portion of the current FOV of the image capturing device 102. The processor 106 is configured to eliminate rays that intersect any voxel marked as occupied in the latest point cloud. The processor 106 marks as free space all points along rays from the grid cells that do not intersect any obstacles, indicating the visible portions of the virtual wall as the navigable space in the local map or the global map.

The processor 106 is configured to optimize processing time by limiting the number of rays cast based on the resolution requirements of the local map. The robotic device 100 identifies navigable space based on processing of the point cloud in real-time, enabling continuous navigation and obstacle avoidance for the robotic device 100 as it moves through the dynamic environment. The processor 106 may be configured to detect and update the local map dynamically by removing obstacle points corresponding to objects that have moved out of the current FOV, allowing for accurate representation of free space in the dynamic environment.

In some embodiments, the processor 106 uses the 3D voxel grid to map navigable and obstacle spaces, allowing for spatial representation and path planning in three-dimensional space for the robotic device 100. The image capturing device 102 may be a stereo depth camera or Time-of-Flight (TOF) sensor configured to generate a depth map by capturing distance data for each point within the current FOV. The processor 106 may apply root cause analysis to address computational complexity issues by optimizing the point cloud processing algorithm, enabling efficient and low-latency identification of navigable space in the dynamic environment.

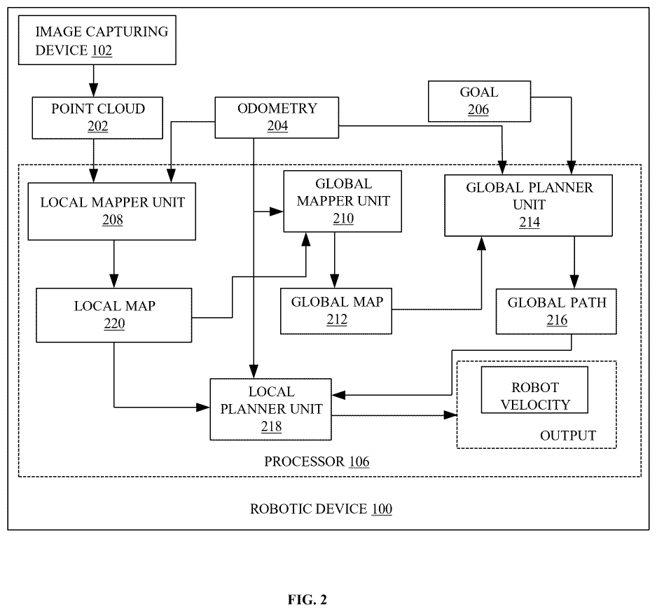

FIG. 2 illustrates an exploded view of the robotic device 100 according to some embodiments herein. The system 100 includes the image capturing device 102 and the processor 106. The image capturing device 102 is configured to capture a point cloud 202 within a current Field-of-View (FOV) of a dynamic environment. The point cloud 202 includes the 3D points corresponding to obstacles in the environment. The point cloud 202 is used to identify both obstacles and free space in the immediate surroundings of the obstacles. An odometry 204 provides a movement information or instruction of the robotic device 100 to track its position in the dynamic environment and a goal 206 specifies a target location or endpoint for the navigation of the robotic device 100.

The processor 106 includes a local mapper unit 208 that receives and processes the point cloud 202 from the image capturing device 102. The local mapper unit 208 processes the point cloud 202 to generate a local map 220 of the environment, mapping the obstacles and free space. The local mapper unit 208 identifies the obstacles within the point cloud 202 by analyzing the 3D points corresponding to the obstacles/objects in the current FOV of the image capturing device 102. The local mapper unit 208 generates the local map 220 by creating a representation of both the obstacles and the navigable/free space within the current FOV of the image capturing device 102. The local map 220 may indicate locations of obstacles and navigable space within the current FOV of the image capturing device 102. The local map 220 is essential for identifying navigable areas/paths and ensuring safe navigation through clear spaces, dynamically updating as the obstacles move or are cleared.

The processor 106 includes a global mapper unit 210 that integrates the local map 220 over time to form a global map 212. The global map 212 represents the entire environment. The global map 212 provides a cumulative and comprehensive view, supporting long-term navigation tasks by tracking both static and dynamic obstacles. The processor 106 includes a global planner unit 214 that uses the global map 212 to compute a global path 216 from a current position of the robotic device 100 to the specified goal 206 i.e. a target location, avoiding known obstacles in the pathway. The global path 216 enables the robotic device 100 to move safely and efficiently across the entire environment.

The processor 106 includes a local planner unit 214 that utilizes both the local map 220 and the global path 216 to dynamically adjust the movement of the robotic device 100, allowing it to navigate around newly detected obstacles within its immediate surroundings. The local planner unit 214 also ensures that the robotic device 100 follows the global path 216 by computing and adjusting velocity of the robotic device 100 whenever required. An output (including the velocity of the robotic device 100) of the processor 106, controls a speed and direction of the robotic device 100 based on the navigable space detected and the global path 216 generated.

The robotic device 100 enables autonomous navigation within the dynamic environment, making real-time adjustments as new obstacles appear and disappear. The robotic device 100 identifies the free space by using the virtual wall at a maximum range (e.g., in a range of 1-3 meters) of the image capturing device 102, which helps fully detect navigable areas/paths even in the absence of obstacles in the current FOV. The robotic device 100 provides a clean and accurate local map, which improves global map accuracy and enhances the agility and navigation accuracy of the robotic device 100.

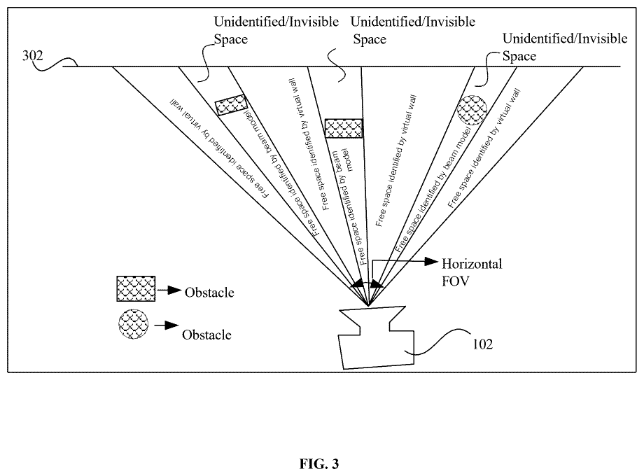

FIG. 3 illustrates an exemplary illustration of the robotic device 100 of FIG. 1 enabling real-time autonomous navigation in a dynamic environment according to some embodiments herein. The exemplary illustration shows a top-down view of the Field of View (FOV) of the image capturing device 102. The image capturing device 102 is configured to capture the point cloud within the current FOV of the environment. The processor 106 generates a virtual wall 302 at a maximum range of the image capturing device 102 within the current FOV. The virtual wall 302 represents the farthest boundary detectable by the image capturing device 102. The processor 106 is configured to projects rays from the origin of the image capturing device 102 towards the virtual wall 302 at varying angles within the horizontal FOV which spans outward in a triangular shape. The image capturing device 102 captures depth information within the FOV, allowing it to detect the obstacles or objects and assess the surrounding space. The processor 106 dynamically identify portions of the virtual wall 302 as the navigable space when a ray intersects the virtual wall 302 without intersecting any obstacle. The obstacles are objects within the FOV of the image capturing device 102 that block lines of sight. The obstacles may be any physical items in the environment that the robotic device 100 needs to avoid during the navigation.

The processor 106 creates the virtual wall 302 at the maximum range of the image capturing device 102 that includes setting the virtual wall 302 to a predefined distance from the image capturing device 102 based on 3D depth sensor's maximum depth range. Any points that the image capturing device 102 detects up to the virtual wall 302 can be used to assess navigable space. Beyond the virtual wall 302, the image capturing device 102 may not be able to access, so that space remains unidentified/invisible space. These unidentified or invisible space or areas are outside the FOV of the image capturing device 102 or beyond the virtual wall 302 (maximum depth cutoff plane).

The free space (i.e. the free region) identified by the virtual wall 302 are part of the space within the FOV where no obstacles are detected up to the maximum range. By assuming the space up to the virtual wall 302 is free, the robotic device 108 can interpret these areas as safe for movement. In free space identified by a beam model of the virtual wall 302, the rays are projected outward from the image capturing device 102, and if the robotic device 100 may not encounter an obstacle before reaching the virtual wall 302, the space the rays pass through is considered as free space. The beam model of the virtual wall 302 helps to dynamically identify free space based on detected obstacles (i.e., free space between the obstacle and the image capturing device 102). The detection of free space is complete within the current FOV of the image capturing device 102, enabling full identification of navigable space as the robotic device 100 moves along a predetermined path.

The processor 106 marks the navigable space traversed by each ray in the local map 220 and updates the local map 220 by clearing any previously marked obstacles that are no longer detected in the point cloud 202 as a result of movement within the dynamic environment. The robotic device 100 navigates along the identified navigable space within the dynamic environment based on the updated local map 220. In some embodiments, the processor 106 is configured to process the point cloud 202 to reduce computational complexity by selectively processing only those data points that lie within a specified portion of the current FOV of the image capturing device 102. The image capturing device 102 may be a stereo depth camera or Time-of-Flight (TOF) sensor configured to generate a depth map by capturing distance data for each point within the current FOV.

The virtual wall 302 provides a solution for scenarios where obstacles might not be present within the FOV, but free space needs to be defined. By creating an imaginary boundary at the maximum range, the robotic device 100 can mark all rays that reach this boundary without intersecting the obstacle as the free region, ensuring that the free region is accurately identified even when there are no obstacles in certain directions, resulting in a complete mapping of navigable space within the FOV. The system 100 allows the robotic device 100 to: (i) detect the obstacles accurately and differentiate them from the navigable space, (ii) identify and mark free space based on depth data, which is essential for safe navigation, and (iii) efficiently clear dynamic obstacles from the local map 220 as they move in and out of the FOV, ensuring the local map 220 remains up-to-date.

FIG. 4 illustrates a block diagram of the robotic device 100 including one or more modules according to some embodiments herein. The robotic device 100 includes the processor 106, and the one or more modules including a point cloud generation module 402, a point cloud receiving module 404, an obstacles identification module 406, a local map generation module 408, a virtual wall generation module 410, a rays projection module 412, a navigable space marking module 414, a local map updating module 416, and an autonomous robot navigation module 418. The one or more modules are communicatively connected with the processor 106.

The point cloud generation module 402 generates the point cloud 202 within the current FOV of the environment using the image capturing device 102. The point cloud 202 includes the 3D points corresponding to the obstacles in the environment. The point cloud receiving module 404 receives and processes the point cloud 202 from the image capturing device 102. In some embodiments, the point cloud receiving module 404 is configured to process the point cloud 302 to reduce computational complexity by selectively processing only those data points that lie within a specified portion of the current FOV of the image capturing device 102. The obstacles identification module 406 identifies the obstacles or objects within the point cloud 202 by analyzing the 3D points corresponding to obstacles/objects in the current FOV. The local map generation module 408 generates the local map 220 by creating a representation of the obstacles within the current FOV. The local map 220 indicates the locations of the obstacles and the navigable space within the current FOV of the image capturing device 102. In some embodiments, the environment can be a two-dimensional (2D) environment.

The virtual wall generation module 410 generates the virtual wall 302 at the maximum range of the image capturing device 102 within the current FOV. The virtual wall 302 represents the farthest boundary detectable by the image capturing device 102. The rays projection module 412 projects the rays from the origin of the image capturing device 102 towards the virtual wall 302 at varying angles within the horizontal FOV, and dynamically identify portions of the virtual wall 302 as a navigable space when a ray intersects the virtual wall 302 without intersecting any obstacle. The navigable space marking module 414 marks the navigable space traversed by each ray in the local map 220. The local map updating module 416 updates the local map 220 by clearing any previously marked obstacles that are no longer detected in the point cloud 202 as a result of movement within the dynamic environment. The autonomous robot navigation module 418 enables the robotic device 100 to navigate along the identified navigable space within the dynamic environment based on the updated local map 220. In some embodiments, the rays used for detecting free space are projected at varying angles within a horizontal FOV of the image capturing device 102 to comprehensively cover the potential navigable space.

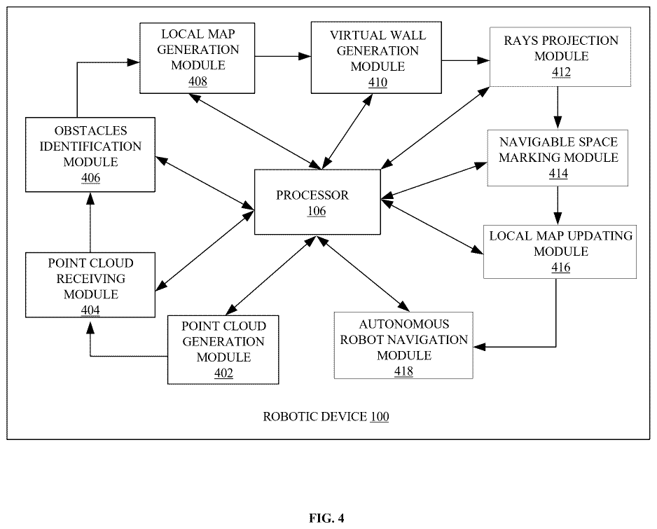

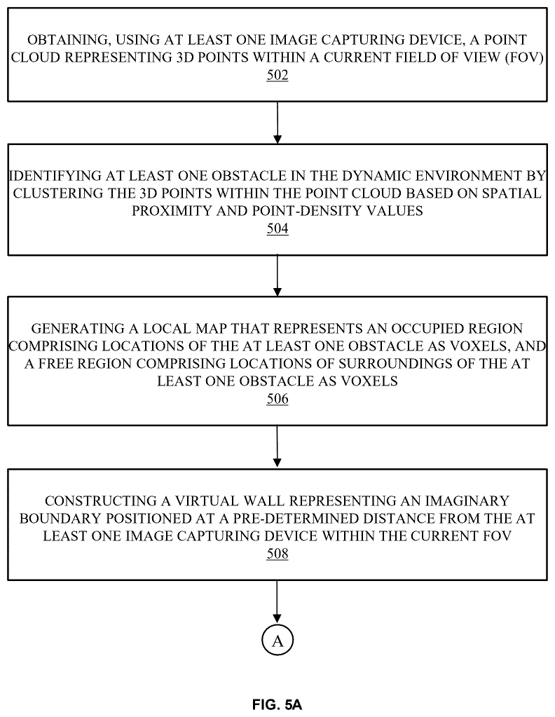

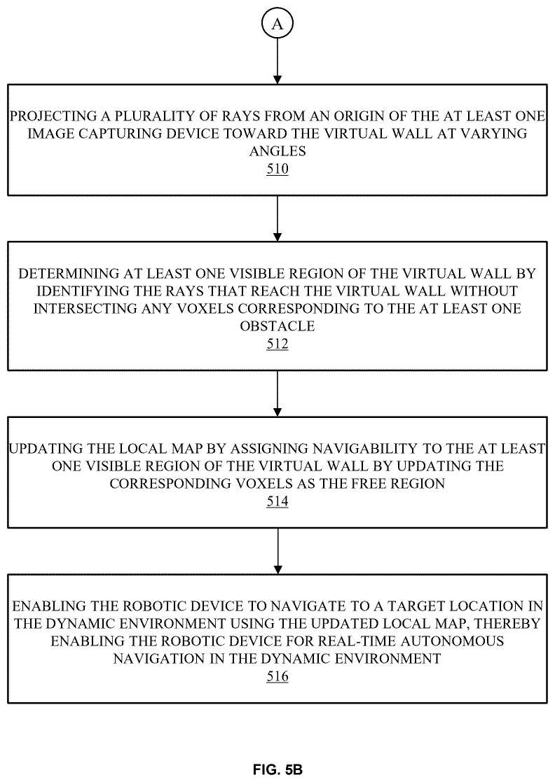

FIGS. 5A and 5B illustrate a method for enabling real-time autonomous navigation in a dynamic environment by determining a navigable space according to some embodiments herein. At a step 502, the method includes obtaining, using at least one image capturing device, a point cloud representing 3D points within a current Field of View (FOV) At a step 504, the method includes identifying at least one obstacle in the dynamic environment by clustering the 3D points within the point cloud based on spatial proximity and point-density values. At a step 506, the method includes generating a local map that represents an occupied region including locations of the at least one obstacle as voxels, and a free region comprising locations of surroundings of the at least one obstacle as voxels. At a step 508, the method includes constructing a virtual wall representing an imaginary boundary positioned at a pre-determined distance from the at least one image capturing device within the current FOV. At a step 510, the method includes projecting a plurality of rays from an origin of the at least one image capturing device toward the virtual wall at varying angles. At a step 512, the method includes determining at least one visible region of the virtual wall by identifying the rays that reach the virtual wall without intersecting any voxels corresponding to the at least one obstacle. At a step 514, the method includes updating the local map by assigning navigability to the at least one visible region of the virtual wall by updating the corresponding voxels as the free region. At a step 516, the method includes enabling the robotic device to navigate to a target location in the dynamic environment using the updated local map, thereby enabling the robotic device for real-time autonomous navigation in the dynamic environment.

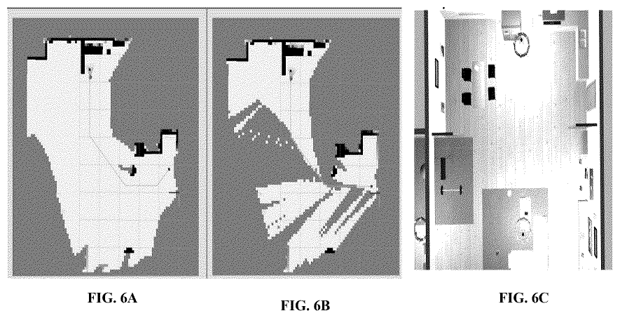

FIGS. 6A-6C illustrate experimental data including a visual evidence and comparison between the robotic system 100 of FIG. 1 and the closest existing approach for real-time obstacle detection and free-space identification in a dynamic environment according to some embodiments herein. In FIG. 6A, the local map 220 generated by the processor 106 of the robotic device 100 shows complete identification of free space within the FOV of the image capturing device 102 as the robotic device 100 navigates from one point to another. The robotic device 100 utilizes the virtual wall 302 to mark all free space, ensuring that the robotic device 100 can safely plan its path without encountering unidentified areas that may be unsafe. In FIG. 6B, the closest existing approach algorithm fails to identify all free space in the FOV, as seen in the gaps and unmarked spaces along the same path. This incomplete identification of free space poses potential navigation risks and limits the robot's efficiency in avoiding obstacles and planning safe paths. FIG. 6C shows a snapshot of the environment used in both scenarios (in FIGS. 6A & 6B) show typical indoor environments with obstacles such as furniture. The snapshot helps substantiate that the robotic device 100 can handle dynamic environments effectively, adapting to changes in real-time, which is essential for autonomous robot 108 navigating indoor spaces with moving objects.

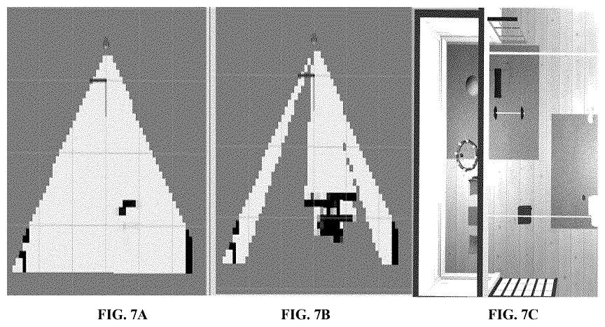

FIGS. 7A-7C illustrate another experimental data including a visual evidence and comparison between the robotic device 100 of FIG. 1 and the closest existing approach for real-time obstacle detection and free-space identification in a dynamic environment according to some embodiments herein. In FIG. 7A, the robotic device 100 dynamically detects and clears obstacles in real-time. When a dynamic obstacle moves within the FOV of the image capturing device 102, the robotic device 100 identifies it immediately and removes its prior location from the local map 220, updating only the current position. This approach prevents stale or outdated obstacle data from impeding navigation, thereby enhancing map accuracy and navigation safety.

In FIG. 7B, the closest existing approach lacks this dynamic updating capability. Once a dynamic obstacle is detected, its position remains on the map even after it moves, causing outdated obstacle data to remain. This can lead to incorrect navigation decisions and prevent the robot from utilizing the free space vacated by the obstacle. FIG. 7C shows a snapshot of the environment used in both scenarios (in FIGS. 7A & 7B) show typical indoor environments with obstacles. The snapshot also shows a box with wheels serves as a dynamic obstacle, moving back and forth to test the system's ability to adapt to real-time changes. The snapshots help substantiate that the robotic device 100 can handle dynamic environments effectively, adapting to changes in real-time, which is essential for autonomous robots navigating indoor spaces with moving objects.

The experimental data demonstrates that the robotic device 100 provides significant advantages over the existing approaches by: (i) offering complete free-space identification in the FOV of the image capturing device 102, reducing the risk of the robotic device 100 encountering unidentified areas, (ii) ensuring real-time obstacle tracking and clearance, allowing for accurate, up-to-date mapping that facilitates safer and more efficient navigation. This experimental data substantiates superior performance in dynamic environments, making it more suitable for applications requiring agile and accurate robotic navigation.

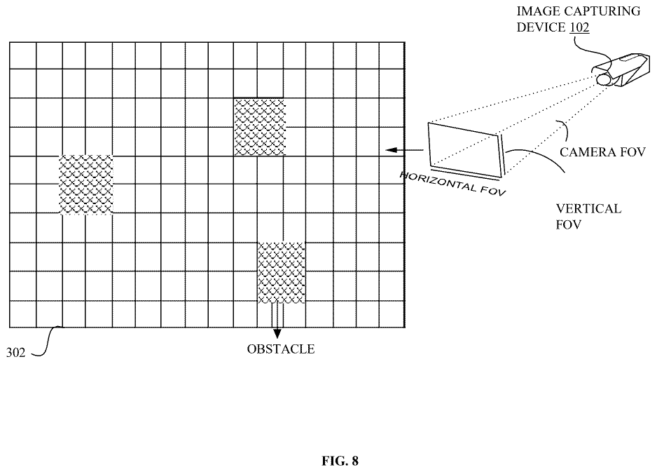

FIG. 8 illustrates an exemplary view of the robotic device 100 for detecting navigable/free space and obstacles in a 3-Dimensional (3D) environment according to some embodiments herein. The robotic device 100 aims to allow free-space identification in 3D environments for applications requiring 3D environment mapping. The processor 106 generates the virtual wall 302 at the maximum range of the image capturing device 102 within the current FOV. The virtual wall 302 in the 3D environment/space is shown as a plane at the maximum depth cutoff within the FOV of the image capturing device 102 i.e. a 3D depth sensor/camera. This plane represents the farthest range that the image capturing device 102 can detect, effectively creating a boundary for identifying free space in the 3D environment. The portion of the virtual wall 302 that falls within the FOV of the image capturing device 102 is divided into a finite grid of smaller squares as shown. This discretization into grids simplifies the process of identifying which areas of the virtual wall 302 are visible and free of obstacles. The rays are cast from the center of each grid square on the virtual wall 302 back to the image capturing device 102. If any ray from a grid square intersects a voxel (3D pixel) marked as occupied by an obstacle in the most recent point cloud data, that ray and corresponding grid cell are marked as blocked or occupied. For all other grids that do not intersect obstacles, points along the ray are marked as free space, indicating the visible portions of the virtual wall 302.

In some embodiments, a 3D extension of the virtual wall 302 technique allows the robotic device 100 to detect the free space even in the absence of obstacles in certain directions, helping the robotic device 100 navigate 3D spaces more effectively. This approach enhances safety by providing a comprehensive 3D map of free and occupied space based on the FOV of the image capturing device 102. The robotic device 100 is particularly useful for robotic applications where understanding both horizontal and vertical free space is critical, such as navigating complex indoor or outdoor environments.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope.

I/We claim:

1. A robotic device that enables real-time autonomous navigation in a dynamic environment by determining a navigable space, wherein the robotic device comprises:
at least one image capturing device that is configured to capture at least one image or video within a current Field of View (FOV) of the dynamic environment, wherein the at least one image or video comprises a point cloud representing 3D points within the current FOV;
a memory that is configured to store one or more instructions; and
a processor that is configured to execute the one or more instructions, wherein the processor is configured to:
obtain the point cloud from the at least one image capturing device;
identify at least one obstacle in the dynamic environment by clustering the 3D points within the point cloud based on spatial proximity and point-density values;
generate a local map that represents an occupied region comprising locations of the at least one obstacle as voxels, and a free region comprising locations of surroundings of the at least one obstacle as voxels;
construct a virtual wall representing an imaginary boundary positioned at a pre-determined distance from the at least one image capturing device within the current FOV;
project a plurality of rays from an origin of the at least one image capturing device toward the virtual wall at varying angles;
determine at least one visible region of the virtual wall by identifying the rays that reach the virtual wall without intersecting any voxels corresponding to the at least one obstacle;
update the local map by assigning navigability to the at least one visible region of the virtual wall by updating the corresponding voxels as the free region; and
enable the robotic device to navigate to a target location in the dynamic environment using the updated local map, thereby enabling the robotic device for real-time autonomous navigation in the dynamic environment.

2. The robotic device of claim 1, wherein the processor is configured to:
generate the local map by converting the point cloud into the voxels; and
assign occupancy values to each voxel of the occupied region and the free region.

3. The robotic device of claim 1, wherein the virtual wall is positioned at a distance corresponding to the maximum measurable range of the at least one image capturing device, wherein the virtual wall is divided into voxels comprising a plurality of grid cells.

4. The robotic device of claim 1, wherein the processor is configured to integrate the local map into a global map that represents a cumulative layout of the environment for longer range navigation.

5. The robotic device of claim 1, wherein the processor is configured to extend the construction of the virtual wall into 3D voxel grids to generate a 3D map of the dynamic environment comprising volumetric occupied region voxels and volumetric free region voxels when the robotic device requires a 3D representation.

6. The robotic device of claim 5, wherein the processor is configured to determine visibility of each grid cell by projecting the plurality of rays from respective centers of the 3D voxel grids on the virtual wall toward the origin of the at least one image capturing device.

7. The robotic device of claim 1, wherein the processor is configured to dynamically clear at least one of: (i) the occupied region associated with previously detected obstacle voxels when corresponding obstacle is not detected in a subsequent point cloud, or (ii) the free region associated with previously detected surrounding voxels when corresponding surroundings is not detected in a subsequent point cloud.

8. The robotic device of claim 1, wherein the processor is configured to:
identify the at least one obstacle by grouping the 3D points into at least one cluster based on a threshold of the spatial proximity value, and
determine an area of the point cloud with point-density values exceeding a threshold of the point-density value.

9. The robotic device of claim 1, wherein the processor is configured to adjust a position or shape of the virtual wall based on calibration data of the at least one image capturing device.

10. A method for enabling real-time autonomous navigation in a dynamic environment by determining a navigable space, wherein the method comprises:
obtaining, using at least one image capturing device, a point cloud representing 3D points within a current Field of View (FOV);
identifying at least one obstacle in the dynamic environment by clustering the 3D points within the point cloud based on spatial proximity and point-density values;
generating a local map that represents an occupied region comprising locations of the at least one obstacle as voxels, and a free region comprising locations of surroundings of the at least one obstacle as voxels;
constructing a virtual wall representing an imaginary boundary positioned at a pre-determined distance from the at least one image capturing device within the current FOV;
projecting a plurality of rays from an origin of the at least one image capturing device toward the virtual wall at varying angles;
determining at least one visible region of the virtual wall by identifying the rays that reach the virtual wall without intersecting any voxels corresponding to the at least one obstacle;
updating the local map by assigning navigability to the at least one visible region of the virtual wall by updating the corresponding voxels as the free region; and
enabling the robotic device to navigate to a target location in the dynamic environment using the updated local map, thereby enabling the robotic device for real-time autonomous navigation in the dynamic environment.
